(19) United States
(12) Patent Application Publication
(10) Pub. No.: US 2016/0202285 A1
(43) Pub. Date: Jul. 14, 2016

(54) Accelerometer Based on Two-Mode Elliptical-Core Fiber Sensor

(71) Applicant: NEC Laboratories America, Inc., Princeton, NJ (US)

(72) Inventors: Ting Wang, West Windsor, NJ (US); Yi Weng, Lafayette, LA (US)

(21) Appl. No.: 14/957,587

(22) Filed: Dec. 2, 2015

Related U.S. Application Data
(60) Provisional application No. 62/101,063, filed on Jan. 8, 2015.

(51) Int. Cl. G01P 15/093; G01H 9/00

(52) U.S. Cl. CPC G01P 15/093; G01H 9/004

(57) ABSTRACT

Systems and methods are disclosed for sensing acceleration or vibration of a physical object, by placing a two-mode elliptical-core optical fiber on the object; receiving optical signals using photo-detector; and determining acceleration as perturbation effects on the differential phase shift between two spatial modes in each polarization or between two polarization modes in each spatial mode for the two-mode elliptical-core optical fiber.

This application claims priority to Provisional Application 62/101,063 filed 2015 Jan. 8, the content of which is incorporated by reference.

### BACKGROUND

The present invention relates to sensing acceleration or vibration of a physical object.

The proliferation of fiber optic sensing systems over the last few decades has been unveiling the enormous potential of this technology in various applications such as smart structures, process monitoring, as well as oil & gas drilling. The main sensing parameters for fiber optic sensors have been strain, temperature, and pressure, which have been proven to have performance characteristics far exceeding those of traditional sensors. Acceleration is also widely recognized as an important controllable environmental parameter both in industrial manufacturing technologies and in laboratory investigations. The development of fiber optic accelerometers and their use in existing markets has been relatively slow in these years, due to the general unfamiliarity of fiber optic accelerometers in the markets. Nonetheless, there has still been a surge in the research of optical accelerometers, because of several advantages optical sensors have over their conventional counterparts, such as light weight, remote sensing capability and the immunity to electromagnetic interference. Accelerometers can be used to measure vibration on buildings, cars, machines, process control systems and safety installations, including construction work such as demolition, drilling, excavating and driving piles, even earthquakes and aftershocks for downhole oil well. There is therefore an urgent need for new optical fiber accelerometer systems capable of both distributed and “smart” sensing, especially for harsh and hazardous environments.

Traditional accelerometers are either capacitive, Hall effect, magneto-resistive, piezo-electric or piezo-resistive based sensors that measure the motion of a structure via the current, which is induced by the inertia forces acting on the material. The response of these sensors is then processed by a signal amplifier and typically converted to a voltage change for detection and acquisition. The capacitance-based accelerometers have gained vast popularity among them, because of the advancements in micro-electro-mechanical systems (MEMS) technology and ease in fabrication. However, these conventional sensors provide rather poor reliability operation in severe environments, such as oil and gas downhole exploration, due to electromagnetic interference in the presence of Radio Frequency interferences (RFI) produced by power electric generators, high voltage power utilities, electrical transformers and similar equipments.

The advantages of fiber optics sensors allow them to function with most severe operating environments, such as in dry deserts, on the ocean floor for seismic sensing, or in the downhole environments for oil and gas production. The most common one was a particular fiber optic accelerometer using the Fiber Bragg Grating (FBG). The FBG sensor experiences a wavelength shift that is linearly proportional to the applied strain, which is analogous to measuring voltage change in a standard accelerometer sensor system. Though it was widely applied due to its inherent optical advantages and multiplexibility, the FBG accelerometers were limited in terms of the maximum allowable acceleration and frequency range. Besides, the volume of the FBG accelerometers is typically larger than that of typical conventional accelerometers, which is usually varied from 1.6 cubic inches to 5.1 cubic inches, costing around $2,000 for a single unit. All of this is a source of high production costs of such sensor as well the high cost of its manufacture. Last but not least, as a point sensor, hundreds or thousands of sensors are needed to monitor a building or pipeline. If one of them is broken, then that blind spot could lead to pipeline accidents.

Distributed optical fiber sensing systems have been studied for a number of applications to overcome this issue of point sensors, for the fibers themselves are used as the sensor head. A single optical fiber can replace thousands of traditional single-point sensors such as the FBG accelerometers. Particularly, dual-parameter measurement schemes, such as simultaneous temperature and strain measurement, can be achieved by operating two-mode optical fibers (TMF) below cut-off which supports the fundamental LP01 and the second order hybrid LP11 modes. Nonetheless, two-mode operation can be unstable because the hybrid LP11 is actually consists of four true modes that have slightly different propagation constants, and the coherent mixing of these modes will result in variation of the hybrid mode intensity pattern along the fiber length and with environmental disturbance. Moreover, the polarization states of the fundamental mode will make the problem even more complicated to solve.

### SUMMARY

In one aspect, systems and methods are disclosed for sensing acceleration or vibration of a physical object, by placing a two-mode elliptical-core optical fiber on the object; receiving optical signals using photo-detector; and determining acceleration as perturbation effects on the differential phase shift between two spatial modes in each polarization or between two polarization modes in each spatial mode for the two-mode elliptical-core optical fiber.

In another aspect, system to sense acceleration or vibration of a physical object includes a two-mode elliptical-core optical fiber on the object; a photo-detector coupled to the fiber to receive optical signals from the object; and a processor coupled to the photo-detector to determine an external disturbance based on a differential phase shift between the modes, affecting a group delay difference Δτ_{GDD}(GDD) and a phase delay difference Δτ_{PDD}(PDD) between two spatial modes or between the two orthogonal polarizations of the same spatial mode.

Advantages of the system may include one or more of the following. The new fiber optic accelerometers utilize the perturbation effects on the differential phase shift between two spatial modes in each polarization or between two polarization modes in each spatial mode for two-mode elliptical-core optical fibers. The sensors are substantially not affected by strong electromagnetic fields in harsh and hazardous environments. As a distributed fiber optic sensor, it presents unique features that have no match in conventional point sensors. A single e-core fiber device can replace thousands of traditional single-point sensors such as the FBG accelerometers. Besides, it outperforms the conventional circular-core TMF because of the stable transverse mode pattern as well as unique phase and group velocity propagation characteristics. The e-core fibers provide a solution to uncontrolled coupling between the modes and instability in the mode patterns of the higher-order modes. Moreover, the fiber optic accelerometer has very wide frequency range, high sensitivity, low self-noise and being universal in measurement direction, along with low cost for its production, installation and maintenance.

### BRIEF DESCRIPTION OF THE DRAWINGS

In order to understand the disclosure and to see how it may be carried out in practice, examples will now be described, by way of non-limiting example only, with reference to the accompanying drawings, in which:

FIG. 1 shows an exemplary transverse electric fields of four modes in elliptical-core two-mode optical fiber.

FIG. 2 shows an exemplary fiber core geometry in the elliptical coordinate system.

FIG. 3 shows an exemplary normalized propagation constant vs. normalized frequency in e-core TMF.

FIG. 4 shows an exemplary flow chart of Accelerometer based on Two-mode Elliptical-core Fiber Sensor

FIG. 5 shows an exemplary system with Accelerometer based on Two-mode Elliptical-core Fiber Sensor.

FIG. 6 shows an exemplary configuration of Accelerometer based on Two-mode Elliptical-core Fiber Sensor.

### DESCRIPTION

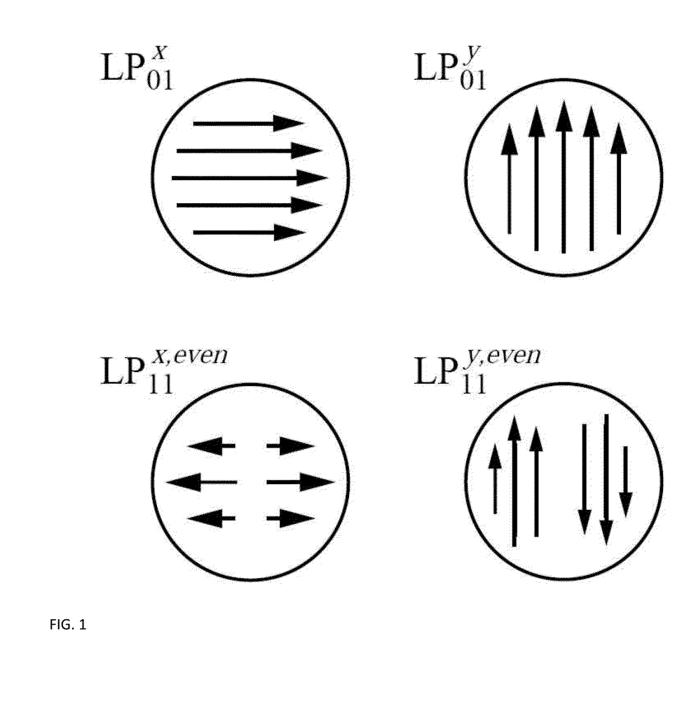

FIG. 1 shows an exemplary transverse electric fields of four modes in elliptical-core two-mode optical fiber. In order to resolve the above-mentioned problems, an embodiment of the disclosure is the use of a dual-mode elliptical-core optical fiber (e-core fiber) device for measuring acceleration when connected respectively to a light source with a short coherence length and a measuring apparatus in harsh and hazardous environments. In an e-core fiber, the hybrid LP11 mode split into two groups with well defined mode intensity patterns, i.e. LP11 odd and LP11 even modes, which have significantly different cut off wavelengths. Since the e-core fiber is operated just below its single-mode cutoff wavelength, so only the first two modes, i.e. LP01 and the LP11 even modes, are allowed to propagate, therefore it can easily overcome the disadvantage of the conventional circular-core TMFs. Small external perturbations and waveguide imperfections will introduce phase-shifts between modes and also make them couple among each other. As the phase difference between the true eigen-modes changes, the orientation of the LP modes will change as well. Therefore, fiber optic accelerometers using elliptical-core optical two-mode fibers can measure acceleration, vibration, strain, displacement, and other quantities with high sensitivity and good stability. The transverse electric fields of four modes in elliptical-core two-mode optical fiber are shown in FIG. 1.

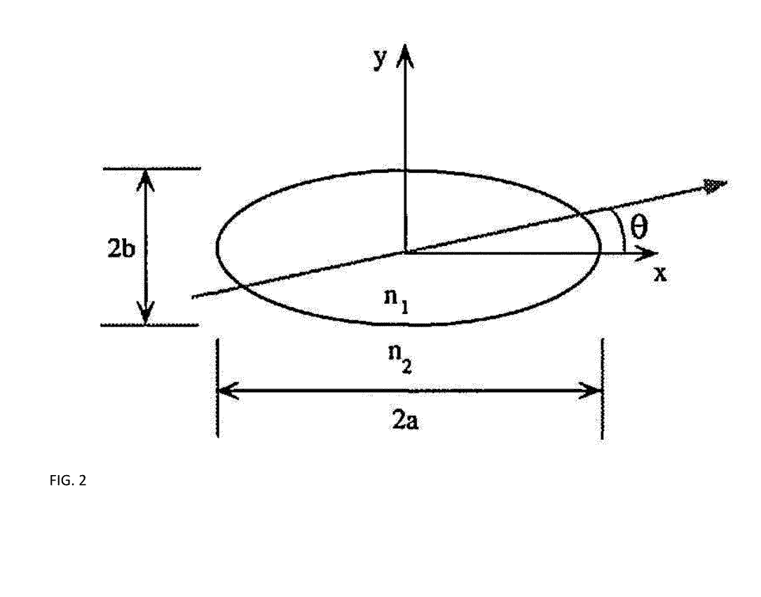

FIG. 2 shows an exemplary fiber core geometry in the elliptical coordinate system. The fiber core geometry in the elliptical coordinate system is shown in FIG. 2, where a, b represent the semimajor (x-direction) and semiminor (y-direction) axes of the fiber core in elliptical core two-mode fiber. Besides, n₁, n₂ are the refractive index of the core and the cladding regions, and θ describes the launch angle of linearly polarized light. The mode spot sizes depend on the operation wavelength λ and the length ratio a/b between the semimajor axis and the semiminor axis of the fiber core. The two-lobe interferential mode patterns have the same profile and distribute symmetrically when the phase difference equals π/2.

The method of analysis involves a measurement of the exchange of optical power between the two lobes in order to determine the nature of the external perturbation, which sequentially results in the variation of the intensity of mode patterns. With the two-mode e-core propagation, an external disturbance causes a differential phase shift between the modes, affecting the group delay difference Δτ_{GDD}(GDD) and the phase delay difference Δτ_{PDD}(PDD) between the two spatial modes or between the two orthogonal polarizations of the same spatial mode.

Suppose the polarization modal birefringence Δβ_{PMB} (PMB) is defined as the difference between the propagation constants of the orthogonal polarization components of the mode, i.e. between LP01ₓ and LP01_{y} or between LP11ₓ even and LP11_{y} even, the GDD between the two orthogonal polarizations of LP01 mode is expressed as:

$$Δ {τ}_{GDD\_P} = \frac{d ( Δ {β}_{PMB} )}{d ω} = - \frac{{λ}^{2}}{2 π c} \frac{d ( Δ {β}_{PMB} )}{d λ}$$

Where λ is the operation wavelength, and c is the light velocity in vacuum. Suppose the spatial mode birefringence Δβ_{SMB} is defined as the difference between the propagation constants of LP01 mode and LP11 even mode, then the group delay difference Δτ_{GDD}(GDD) and the phase delay difference Δτ_{PDD}(PDD) between the two spatial modes are expressed as:

$$Δ {τ}_{GDD\_S} = \frac{d ( Δ {β}_{SMB} )}{d ω} = - \frac{{λ}^{2}}{2 π c} \frac{d ( Δ {β}_{SMB} )}{d λ}$$

$$Δ {τ}_{P DD\_S} = \frac{( Δ {β}_{SMB} )}{ω} = \frac{( Δ {β}_{SMB} ) \cdot λ}{2 π c}$$

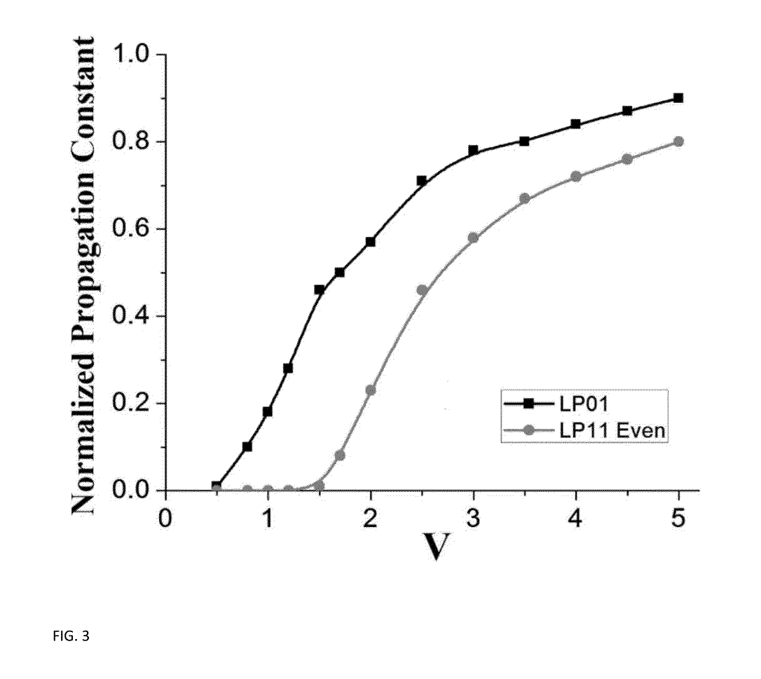

Periodic variations in the intensity patterns, such as oscillation of power between the lobes, are examples of changes which can be used for acceleration sensor. The opto-mechanical design of the accelerometers determines the characteristics of such sensor from linear frequency response range, maximum acceleration, and sensor sensitivity in terms of the wavelength shift corresponding to zero-GDD between two spatial modes and between two orthogonal polarizations of the same spatial mode. FIG. 3 shows an exemplary normalized propagation constant vs. normalized frequency in e-core TMF.

The second-order hybrid degenerate LP11 modes in the conventional circular-core TMFs will cause the polarization state at the output to change in an unpredictable manner, orientation instability in the field pattern, and crosstalk between the modes. The elliptical-core two-mode optical fiber can break the degeneracy between them to avoid such uncontrolled coupling between various modes. Therefore, the fiber optic accelerometer based on e-core TMF has high sensitivity, low self-noise and being universal in measurement direction. Accelerometer designs provide different characteristics in terms of sensitivity, frequency range, and maximum allowable acceleration. The selection of the appropriate accelerometer design will depend on the specific requirements of the sensing applications.

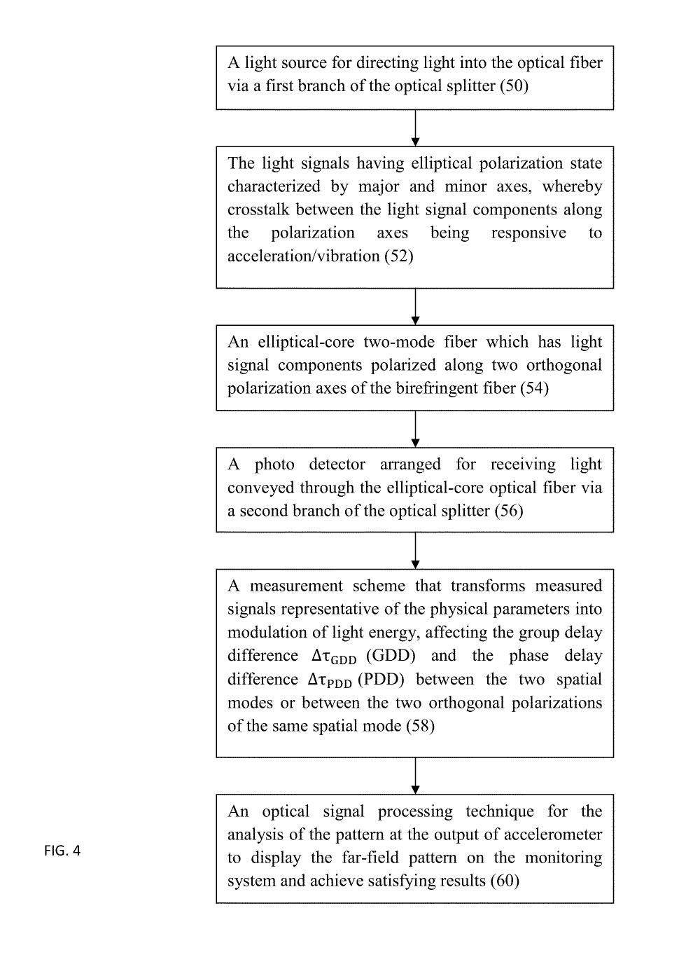

FIG. 4 shows an exemplary flow chart of an accelerometer based on Two-mode Elliptical-core Fiber Sensor. In this process, a light source directs light into the optical fiber via a first branch of the optical splitter (50). The light signals have elliptical polarization state characterized by major and minor axes, whereby crosstalk between the light signal components along the polarization axes are responsive to acceleration/vibration (52). An elliptical-core two-mode fiber is used with light signal components polarized along two orthogonal polarization axes of the birefringent fiber (54). A photo detector is arranged for receiving light conveyed through the elliptical-core optical fiber via a second branch of the optical splitter (56). A measurement processor transforms measured signals representative of the physical parameters into modulation of light energy, affecting the group delay difference Δτ_{GDD}(GDD) and the phase delay difference Δτ_{PDD}(PDD) between the two spatial modes or between the two orthogonal polarizations of the same spatial mode (58). The processor applies optical signal processing for the analysis of the pattern at the output of accelerometer to display the far-field pattern on the monitoring system (60).

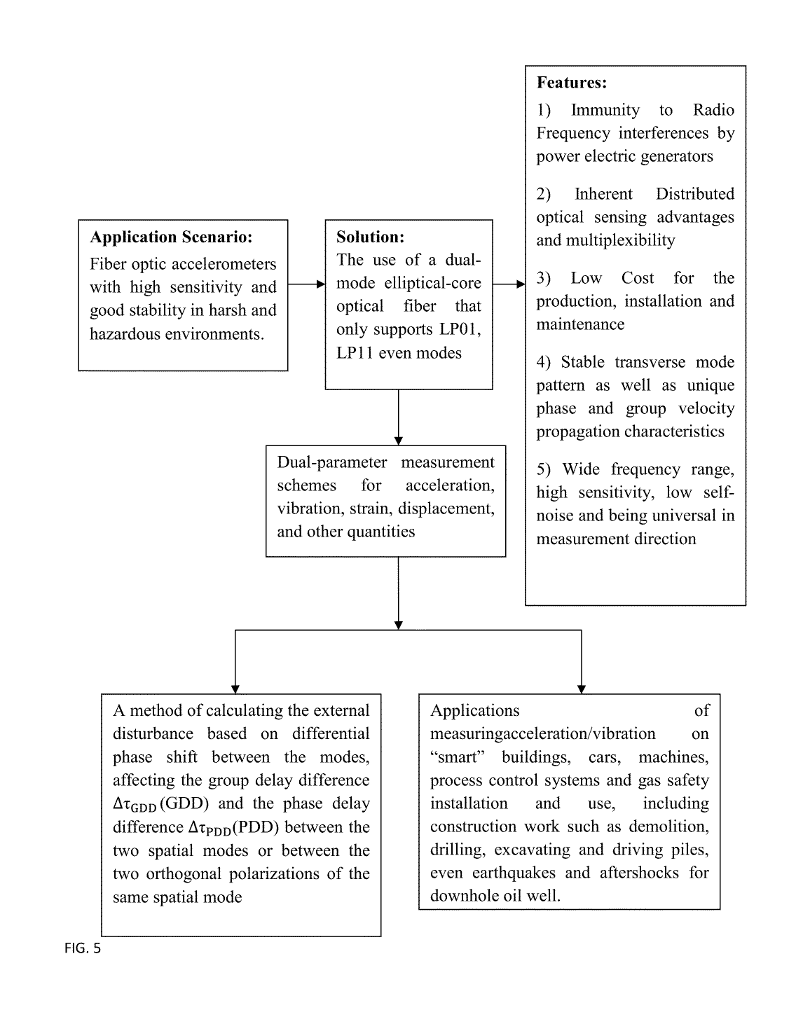

FIG. 5 shows an exemplary system with Accelerometer based on Two-mode Elliptical-core Fiber Sensor. The system provides fiber optic accelerometers with high sensitivity and good stability in harsh and hazardous environments. This is done using a dual-mode elliptical-core optical fiber that only supports LP01, LP11 even modes The system features:
1) Immunity to Radio Frequency interferences by power electric generators
2) Inherent Distributed optical sensing advantages and multiplexibility
3) Low Cost for the production, installation and maintenance
4) Stable transverse mode pattern as well as unique phase and group velocity propagation characteristics
5) Wide frequency range, high sensitivity, low self-noise and being universal in measurement direction.

The system also provides dual-parameter measurement schemes for acceleration, vibration, strain, displacement, and other quantities.

In another aspect, a method is disclosed for calculating the external disturbance based on differential phase shift between the modes, affecting the group delay difference Δτ_{GDD}(GDD) and the phase delay difference Δτ_{PDD}(PDD) between the two spatial modes or between the two orthogonal polarizations of the same spatial mode. The method can be used for measuring acceleration/vibration on “smart” buildings, cars, machines, process control systems and gas safety installation and use, including construction work such as demolition, drilling, excavating and driving piles, even earthquakes and aftershocks for down-hole oil well.

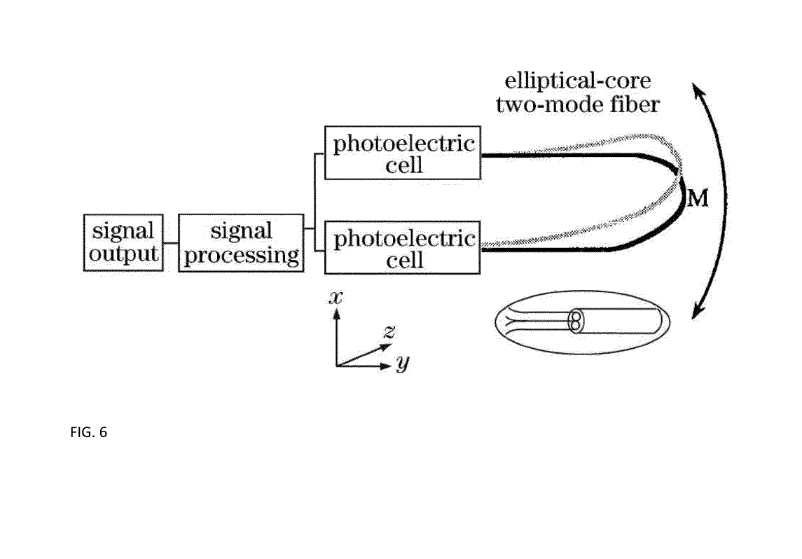

FIG. 6 shows an exemplary configuration of Accelerometer based on Two-mode Elliptical-core Fiber Sensor. In a particular configuration of such accelerometer devices, which has been illustrated in FIG. 6, a half-loop of circular-core two-mode fiber is bent perpendicular to its plane. Bending the loop up and down causes a bipolar phase shift between the LP01 and LP11 modes. This phase shift will then be translated into an electrical signal at photoelectric cells with two acousto-optic frequency shifters as a measurement of the displacement at the midpoint. In this case, the optical fiber acts as a mechanical rod with a spring constant K=EA/L, where E stands for elastic modulus, A means the area, and L is the fiber length. Suppose M is the attached mass, the relation between acceleration a and the strain ε is given by:

$$a = ( \frac{EA}{M} ) * ɛ$$

From the equation above, acceleration is linearly proportional to the applied strain, which is why the fiber optic accelerometers using elliptical-core optical two-mode fibers can measure acceleration, vibration, strain, displacement, and other quantities with high sensitivity and good stability.

Of course, any number of fibers may be used and the plates may assume any size and shape to obtain acceleration measurements. Still further, other housing shapes, fiber shapes, sizes, and arrangements may be used, as desirable.

It should also be noted that any suitable digital or analog signal processing technique(s) may be utilized by the processor in any of the embodiments herein to process the outputs of the sensor(s), including a filter function (such as a low pass filter). The signal processing techniques may be undertaken by a digital or analog signal processing circuit. The circuit may be programmable, hard-wired, a microcontroller, an ASIC, an analog filter, etc.

One or more features of an embodiment disclosed herein may be combined with one or more features of one or more other embodiments. Modifications may be made to any embodiment as should be evident to one of ordinary skill in the art.

It is to be noted that an accelerometer according to at least one example of the present presently disclosed subject matter can comprise any desired number of mounting structures (singly, or in faced pairs, or in staggered pairs, for example), with any desired combination or permutation of different configurations of mounting structures being provided for clamping the respective support ring to the respective housing members, for example any combination of the examples of the mounting structures illustrated herein or alternative variations thereof.

Finally, it should be noted that the word “comprising” as used throughout the appended claims is to be interpreted to mean “including but not limited to”.

While there has been shown and disclosed example examples in accordance with the presently disclosed subject matter, it will be appreciated that many changes can be made therein without departing from the spirit of the presently disclosed subject matter.

What is claimed is:

1. A method for sensing acceleration or vibration of a physical object, comprising:
placing a two-mode elliptical-core optical fiber on the object;
receiving optical signals using photo-detector; and
determining acceleration as perturbation effects on the differential phase shift between two spatial modes in each polarization or between two polarization modes in each spatial mode for the two-mode elliptical-core optical fiber.

2. The method of claim 1, comprising measuring acceleration or vibration for smart buildings, cars, machines, process control systems, gas installations, construction work such as demolition, drilling, excavating and driving piles, earthquakes and aftershocks for down-hole oil well.

3. The method of claim 1, comprising directing light from a light source into the optical fiber via a first branch of an optical splitter.

4. The method of claim 3, wherein the light signal has an elliptical polarization state characterized by major and minor axes with crosstalk between light signal components along the polarization axes responsive to acceleration or vibration.

5. The method of claim 3, comprising positioning the photo detector for receiving light conveyed through the elliptical-core optical fiber via a second branch of the optical splitter.

6. The method of claim 1, wherein the elliptical-core two-mode fiber is used with light signal components polarized along two orthogonal polarization axes of a birefringent optical fiber.

7. The method of claim 1, comprising transforming measured signals representative of physical parameters into modulation of light energy, affecting the group delay difference Δτ_{GDD} (GDD) and the phase delay difference Δτ_{PDD} (PDD) between the two spatial modes or between the two orthogonal polarizations of the same spatial mode.

8. The method of claim 1, comprising optical signal processing to display a far-field pattern.

9. The method of claim 1, comprising bending a half-loop of the two-mode fiber perpendicular to its plane and causing a bipolar phase shift between LP01 and LP11 modes.

10. The method of claim 1, wherein the dual-mode elliptical-core optical fiber only supports LP01, LP11 even modes.

11. A system to sense acceleration or vibration of a physical object, comprising:
a two-mode elliptical-core optical fiber on the object;
photo-detector coupled to the fiber to receive optical signals from the object; and
a processor coupled to the photo-detector to determine an external disturbance based on a differential phase shift between the modes, affecting a group delay difference Δτ_{GDD}(GDD) and a phase delay difference Δτ_{PDD}(PDD) between two spatial modes or between the two orthogonal polarizations of the same spatial mode.

12. The system of claim 11, comprising a light source directs light into the optical fiber via a first branch of the optical splitter.

13. The system of claim 11, wherein light signals have elliptical polarization state characterized by major and minor axes, whereby crosstalk between the light signal components along the polarization axes are responsive to acceleration or vibration.

14. The system of claim 11, wherein the elliptical-core two-mode fiber is used with light signal components polarized along two orthogonal polarization axes of the birefringent fiber.

15. The system of claim 11, wherein the photo detector is arranged for receiving light conveyed through the elliptical-core optical fiber via a second branch of the optical splitter

16. The system of claim 11, wherein the processor applies optical signal processing for analysis of a pattern and display a far-field pattern.

17. The system of claim 11, comprising the processor takes dual-parameter measurements for acceleration, vibration, strain, or displacement.

18. The system of claim 11, comprising a half-loop of circular-core two-mode fiber bent perpendicular to its plane.

19. The system of claim 18, wherein the loop is bent up and down causing a bipolar phase shift between LP01 and LP11 modes.

20. The system of claim 11, wherein the fiber measures acceleration or vibration for smart buildings, cars, machines, process control systems, gas installations, construction work such as demolition, drilling, excavating and driving piles, earthquakes and aftershocks for down-hole oil well.
